(19) United States
(12) Patent Application Publication
(10) Pub. No.: US 2005/0045620 A1
(43) Pub. Date: Mar. 3, 2005

(54) Electric heater

(76) Inventors: Huang Chen-Lung, Tainan City (TW); Huang Chuan Pan, Tainan City (TW)

Correspondence Address: HUANG CHEN-LUNG, NO.17, HSIN-JEN Rd., Tainan City, TW

(21) Appl. No.: 10/653,557

(22) Filed: Aug. 29, 2003

(51) Int. Cl. H05B 3/68

(52) U.S. Cl. 219/465.1

(57) ABSTRACT

An electric heater includes a metal plate, an insulating plate, and an electrothermal film thermally plated on a lower surface of the insulating plate. The electrothermal film generates high temperature, which is then transmitted through the insulating plate to the metal plate. Then the metal plate is heated up to high temperature for use. Then the electric heater is effective, quite safe to use, and adaptable for various electric appliances.

### FIELD OF THE INVENTION

This invention relates to an electric heater, particularly to one having a metal plate with the best heat conducting property for enhancing heat conductivity and stroke-enduring characteristics. Then the electric heater can prevent damage of its surface to result in risks possibly caused by water or electricity leaking.

### BACKGROUND OF THE INVENTION

One of conventional electric heaters disclosed in Taiwan patent of a publicized number. 301523 titled “Electric heater” has a body made of micro-crystal plane glass, and an electrothermal film coated on a lower surface of the micro-crystal plane glass, for generating high heat. This conventional electric heater has a disadvantage of easy damage of the micro-crystal plane glass caused by external force to result in risks of water or electricity leaking,

Another conventional electric heater disclosed in Taiwan patent of a publicized number 319373 titled “Electric water heater with an electrothermal film” has a hollow housing and a heating chamber made of insulating material in the housing, and a heat generating film for heating up the heating chamber. The insulating material of the heating chamber is also micro-crystal plane glass, having the same problem and disadvantage of the above patent No. 301523.

Another conventional electric heater disclosed in Taiwan patent of a publicized number 509453 titled “Electric heating disc” has a heat-conducting disc, a heat generating film piece, heat insulating cotton; and a shell. The high heat generated by the heat generating film piece is transmitted to the heat-conducting disc. The heat generating film piece is a heat-generating tube or piece, indirectly heating the heat-conducting disc, so its heat transmission is comparatively bad.

A last conventional electric heater disclosed in Taiwan patent of a publicized number 427500 titled “Heat generating plate for an electric heater” has a heat generating plate made of a porcelain plate, a glass plate and a steel plate coated with an enamel layer. This conventional electric heater also has the same problem of inferior heat transmission.

### SUMMARY OF THE INVENTION

The purpose of the invention is to offer an electric heater provided with a reinforced heating transmitting surface so as to be used with substantial safety.

One feature of the invention is a metal plate used as a damage-resisting and high heat transmitting means, and an insulating plate located under the metal plate, which has its lower surface formed with a electrothermal film. Then the electrothermal film generates high heat to be transmitted through the insulating plate and then to the metal plate.

Another feature of the invention is the metal plate adhered firmly with the insulating plate with heat conducting glue.

Another feature of the invention is positioning members provided under the metal plate for firmly fixing the insulating plate.

One more feature of the invention is a temperature sensor and a temperature fuse for controlling the temperature of the heater.

### BRIEF DESCRIPTION OF DRAWINGS

This invention will be better understood by referring to the accompanying drawings, wherein:

FIG. 1 is a cross-sectional view of a first embodiment of an electric heater in the present invention;

FIG. 2 is a magnified cross-sectional view of a part marked (A) in FIG. 1;

FIG. 3 is a cross-sectional view of a second embodiment of an electric heater in the present invention;

FIG. 4 is a magnified cross-sectional view of a part marked (B) in FIG. 3;

FIG. 5 is a cross-sectional view of a third embodiment of an electric heater in the present invention;

FIG. 6 is a magnified cross-sectional view of a part marked (C) in FIG. 5;

FIG. 7 is a perspective view of an electric appliance using the electric heater in the present invention;

FIG. 8 is a perspective view of another electric appliance using the electric heater in the present invention;

FIG. 9 is a perspective view of another electric appliance using the electric heater in the present invention; and, FIG. 10 is a perspective view of another electric appliance using the electric heater in the present invention.

### DETAILED DESCRIPTION OF THE PREFERRED EMBODIMENT

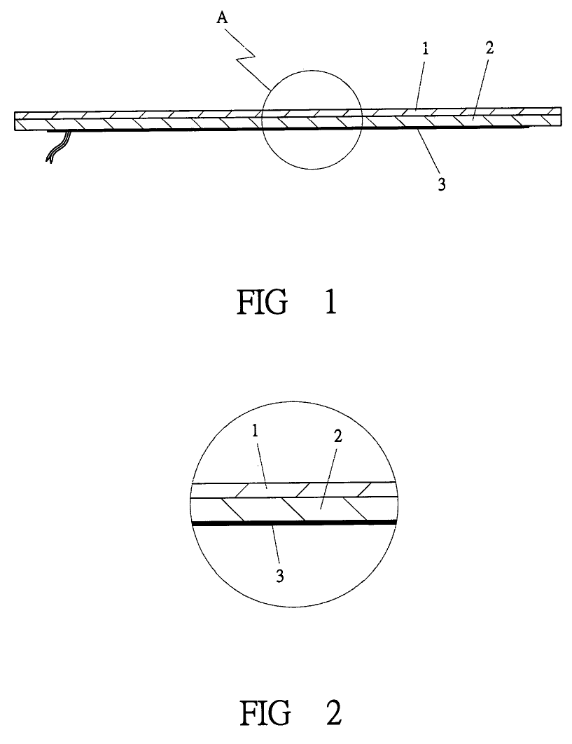

A first embodiment of an electric heater in the present invention, as shown in FIGS. 1 and 2, includes a metal plate 1, an insulating plate 2, and an electrothermal film 3 as main components.

The metal plate 1 may be made of steel, iron, aluminum, aluminum alloy, or stainless steel possessing high heat transmitting coefficient. Above all, steel may be the best for transmitting heat.

The insulating plate 2 to be provided under the metal plate may be a micro-crystal plane glass, a porcelain plate, or a quartz glass possessing electrically insulating property, which is a desirable material.

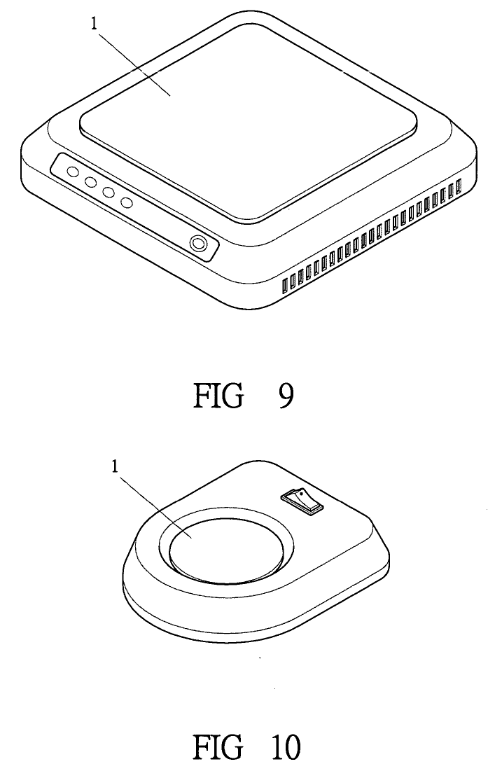

The electrothermal film 3 coated on a lower surface of the insulating plate 2 generates high heat to be transmitted through the insulating plate 2 to the metal plate 1 so as to heat up the metal plate 1, and then the electric heater can be utilized for various electric appliances, as shown in FIGS. 7 to 10 so as to supply the electric appliances with excellent heat transmitting efficiency. Further, the metal plate 1 and the insulating plate 2 may be bonded together by means of heat conductive glue, but it is not absolutely necessary.

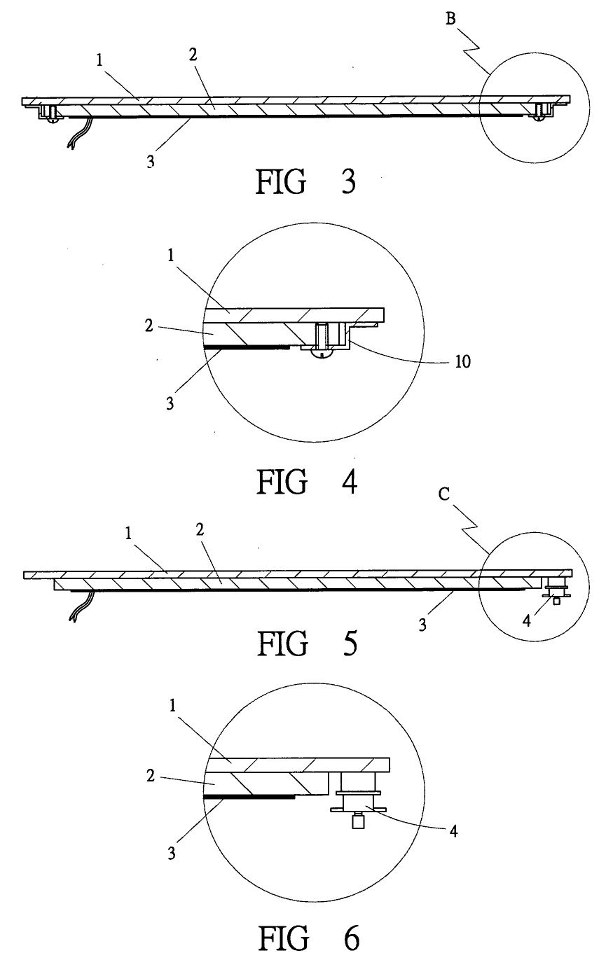

A second embodiment of an electric heater in the invention shown in FIGS. 3 and 4, has the same structure as the first one, but additionally provided with plural positioning members 10 under the metal plate 1 for keeping firmly the insulating plate 2 in position with the metal plate 1.

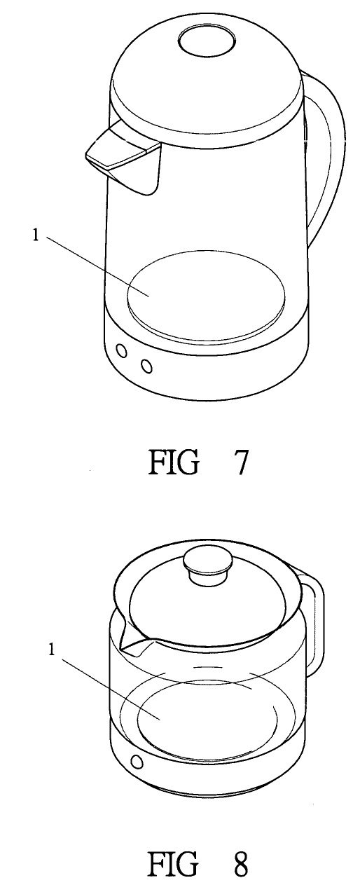

A third embodiment of an electric heater in the invention shown in FIGS. 5 and 6 has the same structure as the first one, but additionally provided with a temperature sensor and a temperature fuse 4 fixed under the metal plate 1 so that the temperature sensor and the temperature fuse 4 can control the proper temperature of the heater.

FIGS. 7 to 10 show various electric appliances using the electric heater as their heat sources.

While the preferred embodiments of the invention have been described above, it will be recognized and understood that various modifications may be made therein and the appended claims are intended to cover all such modifications that may fall within the spirit and scope of the invention.

1. An electric heater comprising:
a metal plate made of material possessing high heat conductive coefficient, an insulating plate fixed under said metal plate, said insulating plate made of electrically insulating material, an electrothermal film thermally plated on a lower surface of said insulating plate, said electrothermal film generating high temperature, said high temperature transmitting through said insulating plate to said metal plate, which is then heated up to high temperature to be used by various electric appliances.

2. The electric heater as claimed in claim 1, wherein said metal plate and said insulating plate are boned together by means of glue conductive to heat.

3. The electric heater as claimed in claim 1, wherein said metal plate is additionally provided with plural positioning members fixed under the lower surface for keeping said insulating plate in position so that both said metal plate and said insulating plate are fixed quite firmly together.

4. The electric heater as claimed in claim 1, wherein a temperature sensor and a temperature fuse are additionally added on a lower surface of the metal plate so as to control the proper temperature of said electric heater.
